(19) United States
(12) Patent Application Publication
(10) Pub. No.: US 2014/0213192 A1
(43) Pub. Date: Jul. 31, 2014

(54) SPECIFIC ABSORPTION RATE REDUCTION

(71) Applicant: HEWLETT-PACKARD DEVELOPMENT COMPANY, L.P., Houston, TX (US)

(72) Inventor: Isaac Lagnado, Houston, TX (US)

(73) Assignee: Hewlett-Packard Development Company, L.P., Houston, TX (US)

(21) Appl. No.: 13/755,309

(22) Filed: Jan. 31, 2013

(51) Int. Cl. H04B 17/00

(52) U.S. Cl. CPC H04B 17/00
USPC 455/67.11

(57) ABSTRACT

Embodiments provide apparatus, methods, and computer readable mediums with programming instructions that enable determinations of specific absorption rates relative to a threshold. In response, a device may alternate use of the first transceiver and the second transceiver to cooperatively transmit an amount of data and reduce the specific absorption rate.

### BACKGROUND

Portable communication devices include but are not limited to mobile phones, smart phones, tablet computers, slate computers, wireless organizers, notebook computers, among others. These devices may communicate voice, images, videos, or other data across wireless networks. When in use, these devices may come into contact with a user or be disposed next to a user such that energy emitted from the device may be absorbed by the user's body. A measurement of such energy is specified as a Specific Absorption Rate (“SAR”).

### BRIEF DESCRIPTION OF THE DRAWINGS

FIG. 1 is a block diagram of an apparatus in accordance with an example of the present disclosure;

FIG. 2 is a block diagram of an apparatus in accordance with an example of the present disclosure;

FIG. 3 is an illustration of a user interacting with an apparatus in accordance with the present disclosure;

FIG. 4 is another illustration of a user interacting with an apparatus in accordance with the present disclosure; and

FIGS. 5-7 illustrate flow diagrams in accordance with various examples of the present disclosure.

### DETAILED DESCRIPTION

Mobile devices including but not limited to mobile phones, smart phones, notebook computers, slate computers, and tablet computers may transmit and receive data wirelessly. The data may include images, text, video, or other data. To receive and transmit the data, the devices may utilize one or more antennas. Utilizing two or more antennas may serve to increase bandwidth. Such configurations are often described as Multiple Input Multiple Output (“MIMO”) systems.

The use of MIMO systems may serve to increase bandwidth or throughput of the mobile system, but it may also have the effect of increasing a Specific Absorption Rate (“SAR”) for the system. SAR is a measurement of the average amount of energy absorbed by a body or user at a particular radio frequency. As additional antennas transmit and receive data, the amount of absorbed energy may also increase.

To reduce SAR for a system, a power level associated with the multiple transmitting antennas may be reduced. This may serve to the lower the SAR, but may also have the unintended consequence of interrupting communications if the computing device is disposed along a boundary of the wireless network.

In the present disclosure, transmission of data from a portable communication device utilizing a multiple antennas to propagate multiple radio frequency signals is discussed. In various examples a computing device utilizing a MIMO system with multiple transmitting streams may first determine whether SAR reduction is needed. For example, if the MIMO system disposes the antennas in a manner such that they are not within a predetermine distance to a user, SAR reduction may not be needed. If SAR reduction is needed, the computing device may perform various operations to mitigate the effects of the multiple antenna streams.

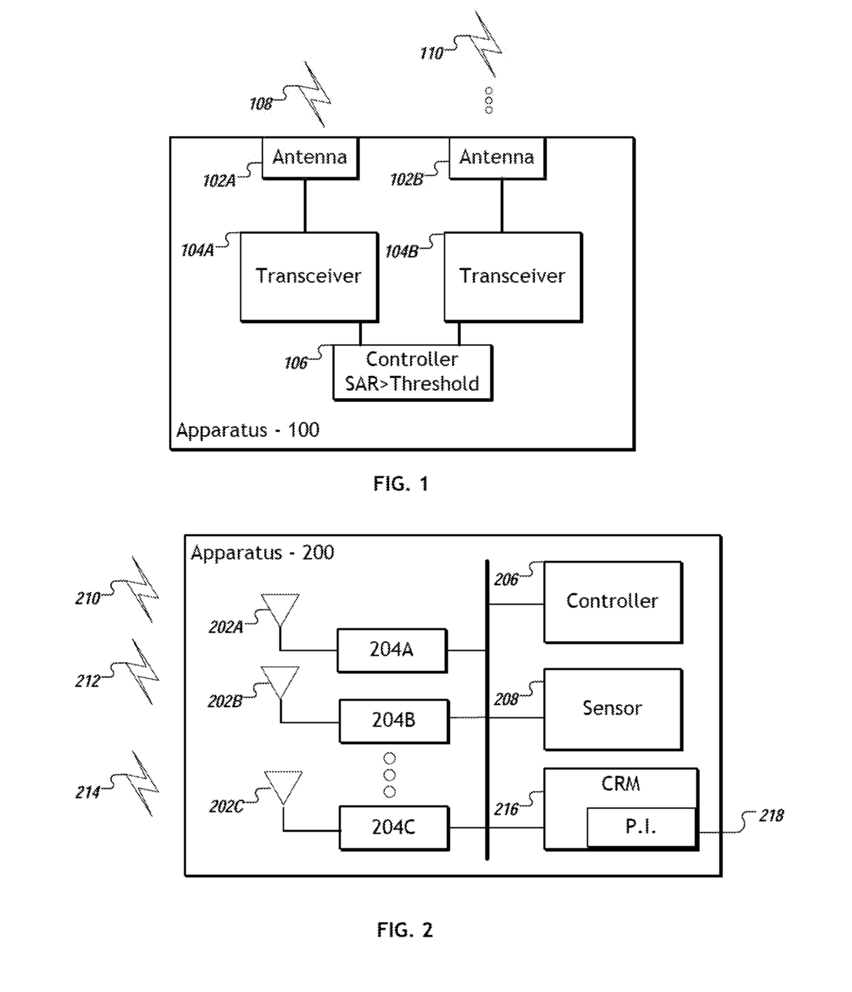

Referring to FIG. 1, an apparatus 100 is illustrated in accordance with one example of the present disclosure. The apparatus 100 may be a portable computing device as previously stated, for example, a notebook computer, a tablet computer, a slate computer, a mobile phone, or a smart phone. The apparatus 100 comprises a first antenna 102A and a second antenna 102B; a first transceiver 104A and a second transceiver 104B, respectively coupled to the first antenna 102A and the second antenna 102B; and a controller 106 coupled to each of the first transceiver 104A and the second transceiver 104B. While illustrated with two antennas and corresponding components, the disclosure is not so limited. Rather, it is expressly contemplated that additional antennas may be utilized without deviating from the teachings of this disclosure.

The first antenna 102A and the second antenna 102B may be antennas related to similar or different wireless technologies. In one example, the first antenna 102A may be configured for use with a first technology while the second antenna 102B may be configured for use with a second technology. In such an example, the first antenna 102A and the second antenna 102B may cooperate to transmit an amount of data via their respective technologies. In another example, the first antenna 102A may be associated with a first technology and the second antenna 102B may be associated with the same technology. Again, the first antenna 102A and the second antenna 102B may be configured to cooperatively transmit data. The antennas 102A-B may be one of multiple types of antennas including but not limited to, dipole antennas, directional antennas, and parabolic antennas, among others.

The transceivers 104A-B are respectively coupled to the first antenna 102A and the second antenna 102B. The transceivers 104A-B are controlled to cooperatively transmit an amount of data. The transceivers 104A-B are to facilitate transmission of data and may include radio frequency chains to up-convert and down-convert signals for receipt and transmission, among other components.

The controller 106 is coupled to the transceivers 104A-B. The controller 106 may be a processor configured to access instructions stored on a non-transitory computer readable medium, an application specific integrated circuit (“ASIC”), a programmable logic device, or another component configured to control at least one other component. In one example, the controller 106 is to determine whether a SAR is above a threshold. In response to determining that the SAR is above a threshold, the controller may alternate use of the first transceiver 104A and the second transceiver 104B to cooperatively transmit the amount of data and reduce the overall SAR.

Still referring to FIG. 1, apparatus 100 may be a tablet computing device with a MIMO architecture. Initially, controller 106 may control transceivers 104A-B and antennas 102A-B to simultaneously transmit an amount of data. Once a user begins interacting with apparatus 100, a SAR limit may need to be monitored. The controller 106 may receive data and determine whether a SAR has exceeded a predefined threshold. In response, the controller 106 may be begin to alternate use of the first antenna 102 with the first transceiver 104A and the second antenna 102B with the second transceiver 104B. More specifically, the controller 106 may alternate an amount of power between the first and second transceivers 104A-B. As illustrated, the first antenna 102A may propagate data 110 for a first period of time, and then the second antenna 102B may propagate data 108 for a second period of time. This may effectively reduce the SAR for the apparatus 100.

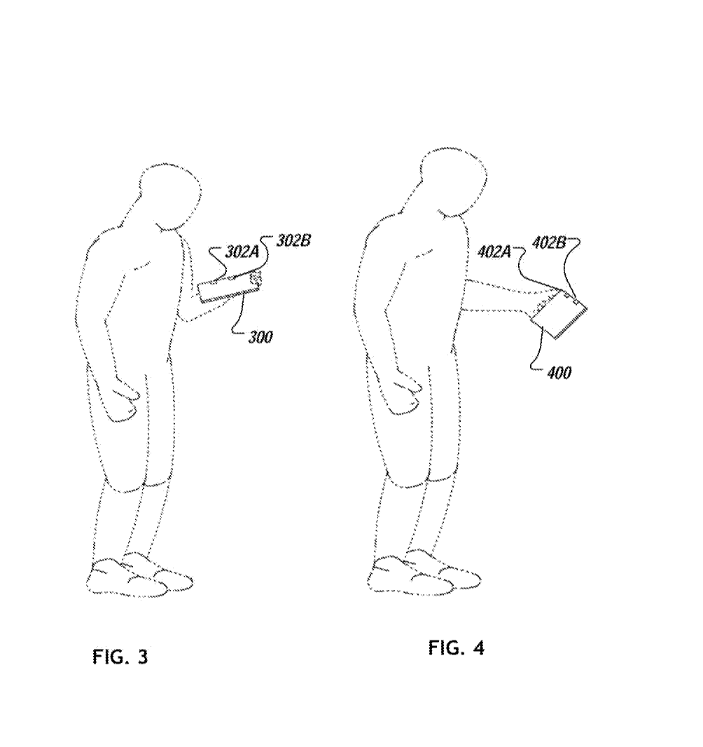

Referring to FIG. 2, another example of an apparatus is illustrated. In the example, apparatus 200 includes a plurality of antennas 202A-C, a plurality of transceivers 204A-C, a controller 206, a sensor 208, and a non-transitory computer readable medium 216 including a plurality of programing instructions 218. The apparatus 200 may be configured to transmit an amount of data 210-214 via the various components.

In the example, the antennas 202A-C and the transceivers 204A-C are generally similar to those discussed with reference to FIG. 1. The components may be associated with similar or different wireless technologies and may function cooperatively to transmit an amount of data utilizing MIMO techniques. The components may be coupled to the controller 206. Again, the controller 206 may be configured to determine that the SAR is above a threshold and alter operation of the antennas 202A-C and transceivers 204A-C to reduce the SAR of the component while transmitting the amount of data 210-214.

Sensor 208 may be coupled to the controller 206 and configured to provide an indication of whether a SAR determination is necessary. For example, if apparatus 200 is operating without a user nearby, for example, if the apparatus is placed on a support, the measurements for SAR are not necessary. However, should a user interact with the apparatus 200, a SAR may necessitate adjustment of the operation of the apparatus 200. In various examples, sensor 208 may be a proximity sensor, an orientation sensor, an accelerometer, a capacitive sensor, or another type of sensor that is capable of determining a presence of a user or a location of a user relative to the apparatus 200.

In one example, sensor 208 is a proximity sensor configured to determine a proximity of a user to the device. For example, the sensor 208 may determine whether a user is within a predetermined distance from apparatus 200 or a portion of the apparatus 200. In various examples, the sensor 208 may be capable of determining proximity to within one or more centimeters. The proximity of the user may trigger the controller to determine whether the SAR is above the threshold. If a user is not within the predetermined distance, the controller 208 may refrain from determining whether a SAR is exceeded.

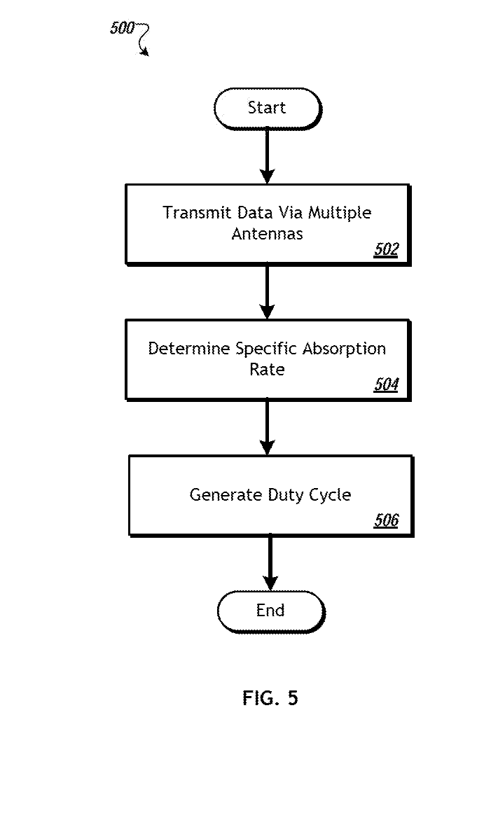

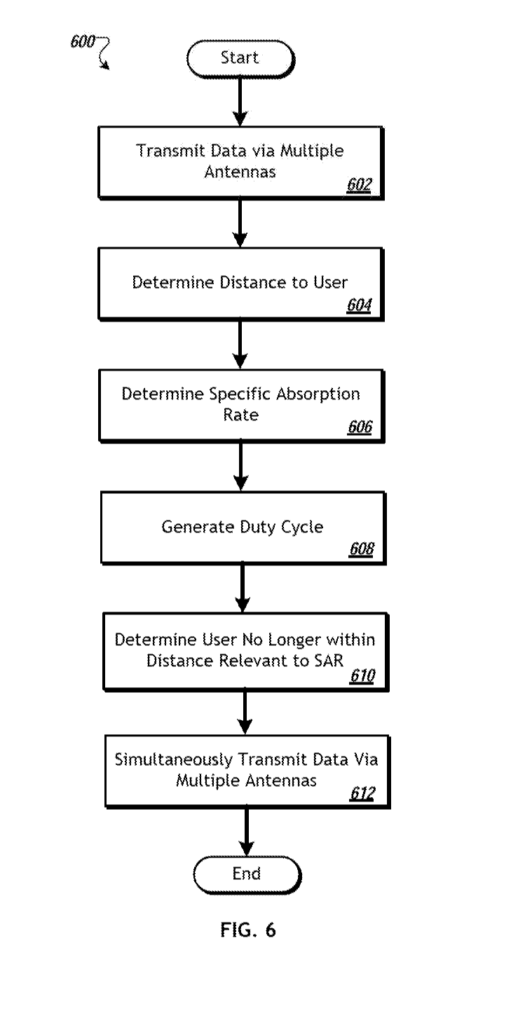

In another example, the sensor 208 may be an orientation sensor configured to determine an orientation of the apparatus 200. Determining an orientation of the apparatus 200 may facilitate a determination of where the antennas 204A-C and transceivers 204A-C are located relative to a user. In one example, the orientation sensor 208 may determine that the apparatus 200 is being utilized in a primary landscape orientation. In a primary landscape orientation, the apparatus 200 may be disposed as seen in FIG. 4. In a primary landscape orientation, the antennas 202A-C may be disposed away from the user, and therefore, the controller may determine that SAR calculations are not needed. Conversely, the orientation sensor may determine that the apparatus 200 is being used in either a portrait orientation or a secondary landscape orientation. A portrait orientation is illustrated in FIG. 3. A secondary landscape orientation may be the reverse of the primary landscape orientation in that the antennas are now directly adjacent to the user. In such instances, the orientation of the device may trigger the controller 208 to determine whether the SAR is above the threshold.

In another example, sensor 208 may be an accelerometer. The accelerometer sensor 208 may be configured to determine whether the apparatus 200 is being held by a user, or alternatively, stationary. In response to a determination of movement, the controller 208 may determine that a user is holding the apparatus 200 and in response, monitor a SAR of the apparatus 200. If the accelerometer sensor 208 determines that the apparatus 200 is stationary, the controller 206 may cease monitoring SAR. In other words, based on a determination of movement from the accelerometer sensor 208, the controller 206 may determine whether to monitor a SAR and that the SAR is above a threshold.

Still referring to FIG. 2, in one example, a first antenna 202A, a second antenna 202B, and a third antenna 202C may be coupled, respectively, to a first transceiver 204A, a second transceiver 204B, and a third transceiver 204C. The controller 206 is to utilize the third transceiver 204C while alternating use of the first transceiver 204A and the second transceiver 204B. In this manner, the transceivers 204A-C may be configured to cooperatively transmit an amount of data 210-214.

In various examples, the apparatus 200 may, in response to the determination that the SAR is above a predetermined threshold, alter a performance characteristic of the apparatus 200. In one example, the controller 206 may alternate use of the first transceiver 202A, the second transceiver 202B, and the third transceiver 202C. Alternating use may enable each data stream to remain at full power while lowering an average SAR across the multiple antennas. In another example, the controller 206 may adjust a power level associated with one or more of the transceivers 204A-C. Adjusting a power level of one or more the transceivers 204A-C may also lower or reduce an average SAR across the multiple antennas. In another example, a controller 206 may both alternate use of the various transceivers 204A-C while additionally adjusting a power level of one of the transceivers 204A-C. This may enable additional SAR reduction.

In examples where the controller 206 is to alter a power level of one or more of the transceivers 204A-C, the controller 206 may determine which antenna to reduce power to, based on various criteria including, an associated wireless technology, placement of the antenna, or placement of the antenna relative to a user. Other criteria are contemplated.

In another example, the non-transitory computer readable medium 216 comprises programming instructions 218, which if executed by controller 206 of the client device 200, cause the client device 200 to determine a location of a user relative to the client device, for example, via sensor 208. Based on the location of the user, the controller 206 may determine a specific absorption rate of data transmissions to be propagated via transceivers 204A-C and antennas 202A-C. In response to a determination that the SAR is above a threshold, the programming instructions 218 may cause the controller 206 to adjust power of the first antenna 202A and the second antenna 202B to reduce the SAR. Adjusting the power may include lowering the power of one or both of the transmissions.

In another example, the programming instructions 218, if executed by the controller 206, may cause the client device to alternate power between the first antenna 202A and the second antenna 202B. Alternating power may decrease an associated bandwidth of the client device 200, but may also reduce the SAR below a predetermined threshold while maintaining connectivity of the device with a remote component.

In various examples, the plurality of programming instructions 218 may enable the controller 206 to continually monitor data received from sensor 208 or to periodically poll sensor 208 to determine whether a user is still located in a position relative to the computing device warranting analysis of the SAR. In response to a determination that a user is not located within a position warranting continued analysis of the SAR, the programming instructions may enable the device to return the first antenna 202A and the second antenna 202B to a pre-adjusted power, or a maximum power.

Referring to FIG. 3, a user is illustrated with a computing device 300. The computing device incorporates components similar to those discussed with reference to FIGS. 1-2. In addition, FIG. 3 illustrates antennas 302A-B disposed on one side of the computing device 300. The computing device 300 is configured for use in multiple orientations. As illustrated, the computing device 300 is utilized in a portrait orientation. In a portrait orientation, the first antenna 302A and the second antenna 302B are adjacent to a user. In such an orientation a SAR measurement may be utilized to determine an amount of energy absorbed by the user. A sensor (not illustrated) as discussed previously may detect whether to trigger the SAR determination.

Referring to FIG. 4, another use is illustrated with a computing device 400. The computing device 400 incorporates components similar to those discussed with reference to FIGS. 1 and 2. In addition, FIG. 4 illustrates antennas 402A-B disposed on one side of computing device 400. The computing device 400, again, is configured for use in multiple orientations. As illustrated, the computing device 400 is illustrated in a primary landscape orientation. As illustrated, the first antenna 402A and the second antenna 402B are disposed at a distal end of the device and therefore at a distant point relative to the user. In such an orientation a SAR measurement may not be needed. A sensor (not illustrated) as discussed previously may detect whether to trigger the SAR determination.

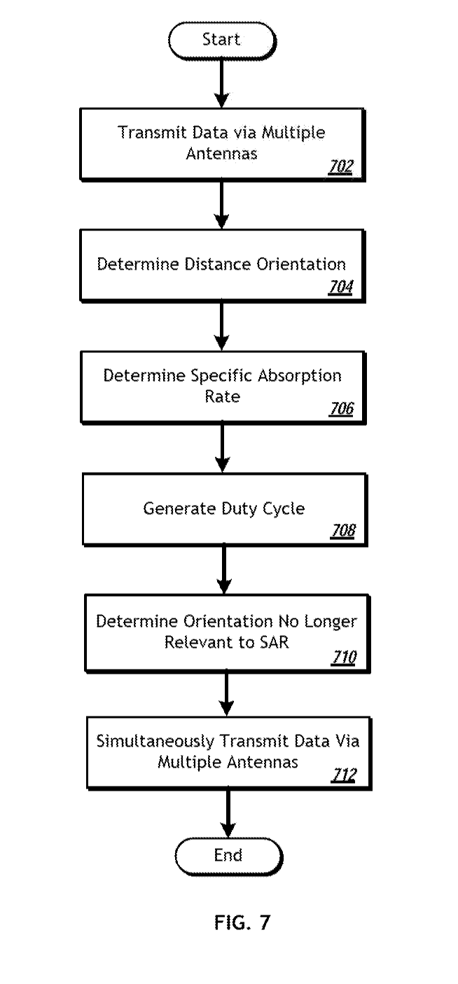

Referring to FIGS. 5-7 various flow diagrams are illustrated in accordance with examples of the present disclosure. While the flow diagrams illustrate various operations in a particular order, the Figures are not meant to limit the present disclosure to any particular order. Additionally, the Figures are not meant to imply that all operations are required for all embodiments.

Referring to FIG. 5, the method may begin and proceed to 502 where a computing device, for example, any of the devices illustrated in the preceding figures may simultaneously transmit an amount of data via a first antenna and a second antenna. The client device may utilize a MIMO architecture to transmit the data. Upon transmitting a portion of the data, the client device may then determine that a SAR is above a predetermined threshold at 504. In response to the determination, the client device at 506 may generate a duty cycle to alternate power between the first antenna and the second antenna to transmit a remaining amount of the data. In various examples, the duty cycle may reduce the specific absorption rate below the predetermined threshold. As used herein a duty cycle is a signal that dictates a percent of time that either the first antenna or the second antenna is active as a fraction of the total time under consideration. The duty cycle is to alternate power, and therefore, transmissions between the first antenna and the second antenna. The method may then end.

Referring to FIG. 6, another flow diagram is illustrated. The flow diagram may begin and proceed to 602 where a computing, for example, any of the devices illustrated in the preceding figures may simultaneously transmit an amount of data via at least a first antenna and a second antenna. In other words, the client device may be a MIMO system that simultaneously transmits data via multiple antennas.

At 604, the client device may determine that a user is within a predetermined distance to the client device. In various examples, a sensor may make the determination utilizing a proximity sensor, an accelerometer, or another sensor. In various examples the predetermined distance may be one or more centimeters. The determination may be that a portion, for example a hand or abdomen of a user, is within the predetermined distance. In another example, the sensor may determine that the client device is experiencing movement, or alternatively is not stationary, and therefore is likely to be within the predetermined distance of a user.

In response to the determination of proximity or movement, the client device may determine that a SAR is above a predetermined threshold at 606. In various examples the threshold may be an upper limit determined by, for example, a governing agency. In response to the determination that the SAR is above the predetermined threshold at 606, the client device may generate a duty cycle to alternate power between the first antenna and the second antenna to transmit the amount of data at 608. The duty cycle may reduce the SAR below the predetermined threshold while in use.

While utilizing the generated duty cycle, the client device may determine that the predetermined threshold is no longer applicable. For example the client device may determine that a user is no longer within the predetermined distance of the client device at 610. The determination may be made via a sensor such as an accelerometer indicating the client device is stationary, or alternatively, by a proximity sensor indicating a user is no longer proximate to the client device.

In response to the determination that the predetermined threshold is no longer applicable, for example due to the lack of movement or the lack of a user within the predetermined distance, the client device begin simultaneously transmitting any remaining portion of the amount of data via the first antenna and the second antenna at 612. In other words, the client device may resume use of multiple antennas to increase a bandwidth. The method may then end.

Referring to FIG. 7, another flow diagram is illustrated. The flow diagram may begin and proceed to 702 where a computing, for example, any of the devices illustrated in the preceding figures may simultaneously transmit an amount of data via at least a first antenna and a second antenna. In other words, the client device may be a MIMO system that simultaneously transmits data via multiple antennas.

At 704, the client device may determine an orientation of the client device relative to a user. The orientation may be determined via a sensor disposed within the client device. The sensor may determine that the device is being utilized in a primary landscape orientation, a secondary landscape orientation, or a portrait orientation.

In response to the determination of orientation the client device may determine that a SAR is above a predetermined threshold at 706. In various examples the threshold may be an upper limit determined by, for example, a governing agency. In response to the determination that the SAR is above the predetermined threshold at 706, the client device may generate a duty cycle to alternate power between the first antenna and the second antenna to transmit the amount of data at 708. The duty cycle may reduce the SAR below the predetermined threshold while in use.

While utilizing the generated duty cycle, the client device may determine that the predetermined threshold is no longer applicable at 710. For example the client device may determine that an orientation of the client device is such that the multiple antennas are no longer within a predetermined distance of the user, for example if the orientation indicates the client device being utilized in a primary landscape orientation.

In response to the determination that the orientation disposes the first antenna and the second antenna a distance from the user, the client device begin simultaneously transmitting any remaining portion of the amount of data via the first antenna and the second antenna at 712. In other words, the client device may resume use of multiple antennas to increase a bandwidth. The method may then end.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a wide variety of ways. This application is intended to cover any adaptations or variations of the embodiments discussed herein. Therefore, it is manifestly intended that embodiments be limited only by the claims and the equivalents thereof.

What is claimed is:

1. A computing system, comprising:
a first antenna and a second antenna;
a first transceiver coupled to the first antenna and a second transceiver coupled to the second antenna, wherein the first transceiver and the second transceiver are to cooperatively transmit an amount of data and
a controller coupled to the first transceiver and the second transceiver to determine that a specific absorption rate is above a threshold, and in response, alternate use of the first transceiver and the second transceiver to cooperatively transmit the amount of data and reduce the specific absorption rate.

2. The computing system of claim 1, further comprising:
a sensor coupled to the controller, wherein the sensor is to determine a proximity of a user, wherein the proximity of the user triggers the controller to determine whether the specific absorption rate is above the threshold.

3. The computing device of claim 1, further comprising:
a sensor coupled to the controller, wherein the sensor is to determine an orientation of the computing device, wherein the orientation triggers the controller to determine whether the specific absorption rate is above the threshold.

4. The computing device of claim 1, further comprising:
a sensor coupled to the controller, wherein the sensor is an accelerometer; and
wherein the controller is determine whether the specific absorption rate is above the threshold in response to determined movement of the computing device via the accelerometer.

5. The computing device of claim 1, wherein the first transceiver is associated with a first wireless technology and the second transceiver is associated with a second wireless technology.

6. The computing device of claim 1, wherein the controller is to alternate power to the first transceiver and the second transceiver to alternate use of the first transceiver and the second transceiver.

7. The computing device of claim 1, wherein the controller is further to adjust a power level of either the first transceiver or the second transceiver during the alternate use of the first transceiver and the second transceiver.

8. The computing device of claim 1, further comprising:
a third antenna coupled to a third transceiver; and
wherein the controller is further to utilize the third transceiver while alternating use of the first transceiver and the second transceiver.

9. A method, comprising:
simultaneously transmitting, by a client device, an amount of data via a first antenna and a second antenna;
determining, by the client device, that a specific absorption rate is above a predetermined threshold;
generating, by the client device, a duty cycle to alternate power between the first antenna and the second antenna to transmit the amount of data, wherein the duty cycle reduces the specific absorption rate below the predetermined threshold.

10. The method of claim 9, further comprising:
determining, by the client device, that a user is within a predetermined distance to the client device; and
wherein determining that the specific absorption rate is above the predetermined threshold is in response to a determination that the user is within the predetermined distance.

11. The method of claim 9, further comprising:
determining, by the client device, an orientation of the client device; and
wherein determining that the specific absorption rate is above the predetermined threshold is in response to determining the orientation.

12. The method of claim 9, further comprising:
determining, by the client device, whether the client device is stationary; and
wherein determining that the specific absorption rate is above the predetermined threshold is in response to a determination that the client device is not stationary.

13. The method of claim 9, further comprising:
determining, by the client device, that the predetermined threshold is no longer applicable; and
simultaneously transmitting, by the client device, a remaining portion of the amount of data via the first antenna and the second antenna.

14. The method of claim 13, wherein determining that the predetermined threshold is no longer applicable comprises determining that orientation of the client device disposes the first antenna and the second antenna a distance from a user.

15. The method of claim 13, wherein determining that the predetermined threshold is no longer applicable comprises determining that a user is no longer within a predetermined distance to the client device.

16. A non-transitory computer readable medium comprising a plurality of programming instructions, which if executed by a controller of the client device, cause the client device to:
determine a location of a user relative to the client device;
determine a specific absorption rate of data transmissions in response to the location of the user relative to the client device; and
adjust power of a first antenna and a second antenna to reduce the specific absorption rate of the data transmissions.

17. The non-transitory computer readable medium of claim 16, wherein the plurality of programming instructions, if executed, further cause the client device to:
alternate power between the first antenna and the second antenna.

18. The non-transitory computer readable medium of claim 16, wherein the plurality of programming instructions, if executed further cause the client device to:
return the first antenna and the second antenna to a pre-adjusted power.
